(19) United States
(12) Patent Application Publication
(10) Pub. No.: US 2009/0171714 A1
(43) Pub. Date: Jul. 2, 2009

(54) LIVE INTENTION MANAGEMENT

(75) Inventors: Michael Muller, Medford, MA (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,627

(22) Filed: Dec. 31, 2007

(51) Int. Cl. G06Q 10/00; G06F 3/14

(52) U.S. Cl. 705/7

(57) ABSTRACT

Embodiments of the present invention address deficiencies of the art in respect to service dispatch and provide a method, system and computer program product for live intention management in a computer communications network. In an embodiment of the invention, a method for live intention management can be provided. The method can include selecting a serviceable object in a service area, changing live intention metadata data for the selected serviceable object to reflect an awareness state of the serviceable object indicating that an actor intends to service but has not yet serviced the serviceable object, and displaying the serviceable object and the awareness state in a map in a graphical user interface.

### BACKGROUND OF THE INVENTION

1. Field of the Invention

The present invention relates to the field of event management for service dispatch and more particularly to object state response tracking for service dispatch.

2. Description of the Related Art

Service dispatch refers to the relationship between actors and objects in a service environment, for example first responders and victims in need of rescue, air traffic controllers and airplanes, tow trucks and disabled vehicles, military attack aircraft and battlefield targets and the like. In service dispatch, objects enjoy different states and actors can respond to the objects according to a contemporaneous state of an object, an actor or both. To accommodate a large number of objects and a correspondingly large number of actors, service dispatch requires a dispatcher empowered to recognize state changes in the objects and to coordinate the actions of actors on the affected objects. Manually managing service dispatch can be challenging where the number of objects is large and where the objects and actors are geographically separate from one another.

The challenge of service dispatch is to optimally assign resources to objects in a new state as required. To assign different actors to provide the same service for a single object in a new state wastes resources. Yet, the dispatcher must be assured that a particular object in a new state receives the attention required by an actor. Thus, computerized monitoring stations have been developed to facilitate the dispatching role. A traditional computerized monitoring station provides a map overlay of a service area and different objects under management positioned in different locations in the map. As objects experience state change, the objects can be visually distinguished in the map and the dispatcher can act by issuing directives to different actors to address the service need of the objects. The directives can be issued through a computer communications network as is the custom with emergency services, or telephonically as is the case with call centers supporting location based services.

Managing the dispatch role is not without its challenges. In many dispatch environments, a high degree of training is required such that the dispatcher knows the available actions to be performed by different actors on an object in a given state. Further, dispatchers in the traditional dispatch environment must coordinate an awareness of the state of many different objects and the progress of actors in completing servicing of respectively assigned objects. The situation can become complicated where an actor intending upon servicing an object requiring service is not accounted for in dispatching a different actor to service the same object.

Specifically, in looser dispatch environments, dispatch merely informs remote units of an object in need of service, and the remote units independently can choose whether or not to address the object in need of service--without the knowledge of the intent of other remote units also available to address the object in need or service. For example, in the roadside assistance scenario, multiple different tow trucks can address the same disabled vehicle independently because each tow truck lacks the knowledge of the intent of each other tow truck. Similarly, in the battlefield context, multiple independent attack aircraft can attack the same target independently because each attack aircraft lacks the knowledge of the intent of each other attack aircraft.

### BRIEF SUMMARY OF THE INVENTION

Embodiments of the present invention address deficiencies of the art in respect to service dispatch and provide a novel and non-obvious method, system and computer program product for live intention management in a computer communications network. In an embodiment of the invention, a method for live intention management can be provided. The method can include selecting a serviceable object in a service area, changing live intention metadata data for the selected serviceable object to reflect an awareness state of the serviceable object indicating that an actor intends to service but has not yet serviced the serviceable object, and displaying the serviceable object and the awareness state in a map in a graphical user interface.

The method also can include changing live intention metadata for the actor to reflect an availability state of the actor indicating the committed nature of the actor in intending to service the serviceable object, and displaying the actor and the availability state in the map. Further, the method also can include further selecting a different serviceable object in a service area, changing live intention metadata data for the further selected serviceable object to reflect a different awareness state of the different serviceable object indicating that a different actor is servicing the different serviceable object, and displaying the different serviceable object and the different awareness state in the map in the graphical user interface.

Even yet further, the method also can include further selecting a different serviceable object in a service area, changing live intention metadata data for the further selected serviceable object to reflect a different awareness state of the different serviceable object indicating that a different actor has completed servicing the serviceable object, and displaying the different serviceable object and the different awareness state in the map in the graphical user interface. In the latter instance, the method also can include removing the display of the different serviceable object, the different awareness state or both from the map in the graphical user interface.

In one aspect of the embodiment, displaying the serviceable object and the awareness state in a map in a graphical user interface further can include identifying the actor intending to service the serviceable object. In another aspect of the embodiment, displaying the serviceable object and the awareness state in a map in a graphical user interface further can include displaying at least one required role necessary to address the awareness state. In yet another aspect of the embodiment, displaying the serviceable object and the awareness state in a map in a graphical user interface further can include displaying an estimated workload for servicing the serviceable object in the awareness state.

In yet another aspect of the embodiment, identifying the actor intending to service the serviceable object further can include identifying an object intended to be serviced by the actor. In even yet another aspect of the embodiment, identifying the actor intending to service the serviceable object further can include identifying a duration of time necessary to service an object intended to be serviced by the actor. This value can be presented as a period of time remaining or an absolute time and can be based upon the estimated workload for servicing the serviceable object in the awareness state. Finally, in even yet another aspect of the embodiment, identifying the actor intending to service the serviceable object further can include identifying abilities of the actor.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of service dispatch area configured for live intention management;

FIGS. 2A and 2B, taken together, are block diagrams illustrating live intention meta-data for a serviceable object and a servicing actor, respectively;

FIG. 3 is a schematic illustration of a service dispatch data processing system for live intention management over a computer communications network; and,

FIGS. 4A and 4B, taken together, are a flow chart illustrating a process for live intention management.

### DETAILED DESCRIPTION OF THE INVENTION

Embodiments of the present invention provide a method, system and computer program product for live intention management. In accordance with an embodiment of the present invention, serviceable objects in a service area can be associated in a computing environment with live intention metadata. The live intention metadata can specify among other things an awareness state of service and an indication of an actor or one or more roles addressing the awareness state of the serviceable object. Live intention metadata also can be associated with actors in the service area. The live intention metadata when associated with an actor can specify an availability of the actor and, optionally, a serviceable object in the service area addressed by the actor. Finally, the live intention metadata can be expressed in a graphical user interface in connection with respective ones of the serviceable objects and actors. In this way, the intention to service a serviceable object by one actor in the service area can be recognized by other actors in the service area.

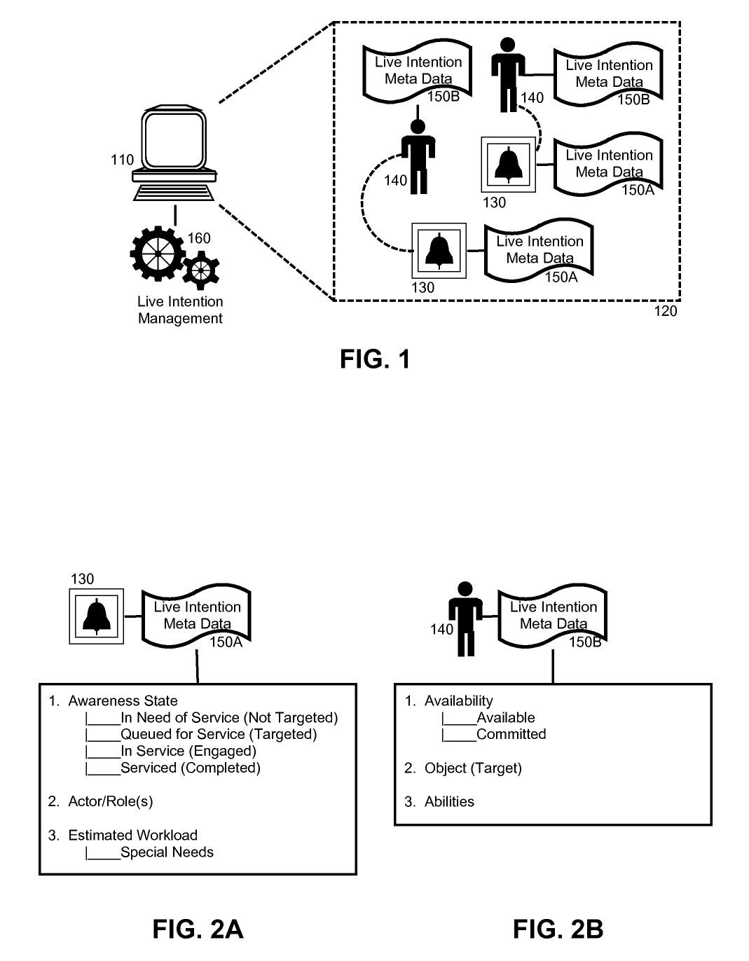

In further illustration, FIG. 1 is a pictorial illustration of service dispatch area configured for live intention management. As shown in FIG. 1, serviceable objects 130 in a service area 120 can be accounted for in a computing system 110. The serviceable objects 130 can include, by way of example, persons in need of assistance or rescue, disabled vehicles, and battlefield targets. Actors 140 engaged to service the serviceable objects 130 in the service area 120 further can be accounted for in the computing system 110. The actors 140 can include, by way of example, first responders and rescue units, tow trucks, and attack aircraft.

Notably, live intention metadata 150A can be associated with each of the serviceable objects 130. Similarly, live intention metadata 150B can be associated with each of the actors 140. A live intention management process 160 executing in the computing system 110 can read the live intention metadata 150A, 150B in order to provide a graphical user interface display of the serviceable objects 130 and the intention of individual ones of the actors 140 in servicing the serviceable objects 130. Optionally, the live intention management process 160 can read the live intention metadata 150A, 150B in order to provide a graphical user interface display of the actors 140 in respect to the serviceable objects 130 and the intention of the actors 140 in servicing the serviceable objects 130.

The content of the live intention metadata 150A can vary amongst the serviceable objects 130. In illustration, referring to FIG. 2A, minimally, the live intention metadata 150A can include an awareness state and an actor addressing the awareness state. The awareness state can include a discrete number of states ranging from “in need of service” to “queued for service” to “in service” to “serviced”. Optionally, the live intention metadata 150A also can specify a required role or roles of an actor in the service area necessary address the awareness state. As yet another option, an estimated workload to address the awareness state can be included as can any special needs such as “defibrillator required” or “jumper cables” or “specific type of ordinance”.

Referring now to FIG. 2B, the live intention metadata 150B for the actor minimally can include an indication of availability. The indication of availability can range from “available” to “committed”. Optionally, the live intention metadata 150B can indicate a serviceable object being addressed by the actor. As yet another option, one or more capabilities of the actor can be specified in the live intention metadata 150B. In this way, a mere inspection of the live intention metadata 150B can indicate whether or not an associated actor can be dispatched to service a serviceable object and also whether or not the actor has capabilities necessary to service the serviceable object.

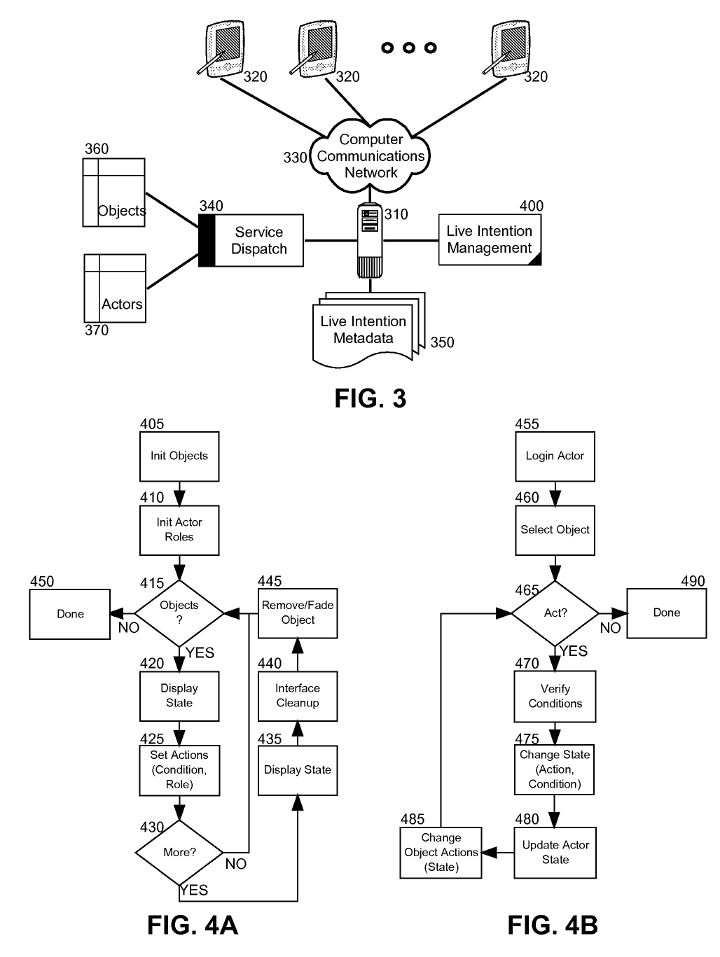

The live intention management process described herein can be performed in a service dispatch data processing system. In illustration, FIG. 3 schematically depicts a service dispatch data processing system for live intention management over a computer communications network. The system can include a host server 310 configured for communicative coupling to multiple different computing devices 320 over computer communications network 330. The computing devices 320 can include devices of portability such as personal digital assistants, wireless computers, smart phones and the like. The computing devices 320 further can include general personal computers. Each of the computing devices 320 can be associated with one or more actors 370 in a service area, one or more serviceable objects 360 in a service area, or both.

A service dispatch system 340 can be coupled to the host server 310. The service dispatch system 340 can be configured to post messages to the computing devices 320 associated with one or more of the actors 370 in the service area describing one or more serviceable objects 360 requiring service in the service area. The service dispatch system 340 further can be configured to receive messages from the computing devices 320 associated with one or more of the actors 370 in the service area describing an availability state and an identity of one of the serviceable objects 360 being serviced by a corresponding one of the actors 370.

Notably, live intention management logic 400 can be provided in connection with the service dispatch system 340. The live intention management logic 400 can include program code enabled to read and manage live intention metadata 350 for each of the serviceable objects 360 and actors 370 in the service area. In this regard, the program code can be enabled to change the awareness state of the live intention metadata 350 for a given one of the serviceable objects 360 and a respective one of the actors 370 as the respective one of the actors 370 addresses the awareness state of the given one of the serviceable objects 360. Throughout, the program code can be enabled to render a map showing each of the serviceable objects 360 (and optionally each of the actors 370) and some or all of associated live intention metadata 350 in response to a selection by an end user in the map.

In yet further illustration of the operation of the live intention management logic 400, FIGS. 4A and 4B, taken together, are a flow chart illustrating a process for live intention management. Beginning in block 405, serviceable objects in a service area can be initialized and in block 410, one or more actor roles can be initialized as well to respond to dispatch directives for servicing the serviceable objects in response to a state change in awareness state for the serviceable objects. In decision block 415, if the serviceable objects in the service area are determined to have entered an awareness state requiring service, in block 420 the current awareness state of the serviceable object can be displayed in connection with the serviceable object in a map of the service area. Additionally, in block 425 one or more required actions and required roles can be indicated.

In decision block 430 if the serviceable object has been sufficiently serviced such that the serviceable object has reached an awareness state of completion, in block 435 the final state can be displayed in the map accounting for an actor having addressed the awareness state and in block 440 the map can be cleansed to remove extraneous artifacts. Thereafter, in block 445 the serviceable object can be removed or faded from view in the map and the process can return to decision block 415. In decision block 415, when no further serviceable objects remain to have service dispatched in block 450 the process can end.

Turning now to FIG. 4B, in block 455 an actor can log in to the system and in block 460 a serviceable object requiring service in the service area can be selected for processing. In decision block 465, it can be determined whether or not the actor has addressed a serviceable object in an awareness state requiring service by an actor or an actor fulfilling a specific role. If not, the process can end in block 390. Otherwise, in block 370 the actor can verify from the live intention metadata for the serviceable object that another actor has not already expressed intent to address the awareness state. Thereafter, in block 375 the state of the serviceable object can be changed to reflect that the actor intends to address the awareness state. Optionally, in block 380 the availability state for the actor further can be changed to reflect that the actor intends to address the awareness state of the serviceable object Finally, in block 385 the requisite actions to be performed on the serviceable can change responsive to the addressing the awareness state.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A live intention management method, the method comprising:
selecting a serviceable object in a service area;
changing live intention metadata data for the selected serviceable object to reflect an awareness state of the serviceable object indicating that an actor intends to service but has not yet serviced the serviceable object; and,
displaying the serviceable object and the awareness state in a map in a graphical user interface.

2. The method of claim 1, further comprising:
changing live intention metadata for the actor to reflect an availability state of the actor indicating the committed nature of the actor in intending to service the serviceable object; and,
displaying the actor and the availability state in the map.

3. The method of claim 1, further comprising:
further selecting a different serviceable object in a service area;
changing live intention metadata data for the further selected serviceable object to reflect a different awareness state of the different serviceable object indicating that a different actor is servicing the different serviceable object; and,
displaying the different serviceable object and the different awareness state in the map in the graphical user interface.

4. The method of claim 1, further comprising:
further selecting a different serviceable object in a service area;
changing live intention metadata data for the further selected serviceable object to reflect a different awareness state of the different serviceable object indicating that a different actor has completed servicing the serviceable object; and,
displaying the different serviceable object and the different awareness state in the map in the graphical user interface.

5. The method of claim 4, further comprising removing the display of the different serviceable object and the different awareness state from the map in the graphical user interface.

6. The method of claim 1, wherein displaying the serviceable object and the awareness state in a map in a graphical user interface, further comprises identifying the actor intending to service the serviceable object.

7. The method of claim 1, wherein displaying the serviceable object and the awareness state in a map in a graphical user interface, further comprises displaying at least one required role necessary to address the awareness state.

8. The method of claim 1, wherein displaying the serviceable object and the awareness state in a map in a graphical user interface, further comprises displaying an estimated workload for servicing the serviceable object in the awareness state.

9. The method of claim 6, wherein identifying the actor intending to service the serviceable object, further comprises identifying an object intended to be serviced by the actor.

10. The method of claim 6, wherein identifying the actor intending to service the serviceable object, further comprises identifying abilities of the actor.

11. A live intention management data processing system comprising:
a host server configured for communicative coupling to a plurality of computing devices over a computer communications network;
a service dispatch system coupled to the host server; and,
live intention management logic coupled to the service dispatch system, the logic comprising program code enabled to select a serviceable object in a service area, to change live intention metadata data for the selected serviceable object to reflect an awareness state of the serviceable object indicating that an actor intends to service but has not yet serviced the serviceable object, and to display the serviceable object and the awareness state in a map in a graphical user interface.

12. The system of claim 11, wherein the serviceable objects are persons in need of rescue and the actors are first responders.

13. The system of claim 11, wherein the serviceable objects are battlefield targets and the actors are attack aircraft.

14. A computer program product comprising a computer usable medium embodying computer usable program code for live intention management, the computer program product comprising:
computer usable program code for selecting a serviceable object in a service area;
computer usable program code for changing live intention metadata data for the selected serviceable object to reflect an awareness state of the serviceable object indicating that an actor intends to service but has not yet serviced the serviceable object; and,
computer usable program code for displaying the serviceable object and the awareness state in a map in a graphical user interface.

15. The computer program product of claim 14, further comprising:
computer usable program code for changing live intention metadata for the actor to reflect an availability state of the actor indicating the committed nature of the actor in intending to service the serviceable object; and,
computer usable program code for displaying the actor and the availability state in the map.

16. The computer program product of claim 14, further comprising:
computer usable program code for further selecting a different serviceable object in a service area;
computer usable program code for changing live intention metadata data for the further selected serviceable object to reflect a different awareness state of the different serviceable object indicating that a different actor is servicing the different serviceable object; and,
computer usable program code for displaying the different serviceable object and the different awareness state in the map in the graphical user interface.

17. The computer program product of claim 14, further comprising:
computer usable program code for further selecting a different serviceable object in a service area;
computer usable program code for changing live intention metadata data for the further selected serviceable object to reflect a different awareness state of the different serviceable object indicating that a different actor has completed servicing the serviceable object; and,
computer usable program code for displaying the different serviceable object and the different awareness state in the map in the graphical user interface.

18. The computer program product of claim 17, further comprising computer usable program code for removing the display of the different serviceable object and the different awareness state from the map in the graphical user interface.

19. The computer program product of claim 14, wherein the computer usable program code for displaying the serviceable object and the awareness state in a map in a graphical user interface, further comprises computer usable program code for identifying the actor intending to service the serviceable object.

20. The computer program product of claim 14, wherein the computer usable program code for displaying the serviceable object and the awareness state in a map in a graphical user interface, further comprises computer usable program code for displaying at least one required role necessary to address the awareness state.

21. The computer program product of claim 14, wherein the computer usable program code for displaying the serviceable object and the awareness state in a map in a graphical user interface, further comprises computer usable program code for displaying an estimated workload for servicing the serviceable object in the awareness state.

22. The computer program product of claim 19, wherein the computer usable program code for identifying the actor intending to service the serviceable object, further comprises computer usable program code for identifying an object intended to be serviced by the actor.

23. The computer program product of claim 19, wherein the computer usable program code for identifying the actor intending to service the serviceable object, further comprises computer usable program code for identifying abilities of the actor.
